(19) United States
(12) Patent Application Publication
(10) Pub. No.: US 2005/0013127 A1
(43) Pub. Date: Jan. 20, 2005

(54) Back light module with grooved light guide plate and method for manufacturing the same

(76) Inventor: Kung-Jung Tsai, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/894,599

(22) Filed: Jul. 19, 2004

(30) Foreign Application Priority Data
Jul. 18, 2003 (TW) 92119708

(51) Int. Cl. F21V 8/00

(52) U.S. Cl. 362/31

(57) ABSTRACT

A back light module (100) includes a number of light sources (110), and a light guide plate (120) defining a corresponding number of grooves (124) in one peripheral side (121) thereof. Each light source is positioned corresponding to a respective groove of the light guide plate. Light beams generated by each light source, especially those light beams at extremities of the light source's emission angle ), can therefore penetrate through the peripheral surface of the light guide plate without refraction. Darkened areas (125) of the light guide plate are thus reduced in size.

### BACKGROUND OF THE INVENTION

1. Field of the Invention

The present invention relates generally to a back light module for a liquid crystal display and a method for manufacturing the same, and more particularly to a back light module for a liquid crystal display that can reduce darkened areas.

2. Prior Art

A liquid crystal display has the advantages of light weight, thinness and low power consumption compared with other kinds of electronic displays such as cathode ray tubes, and application in modern information and electronic products is ubiquitous. However, the liquid crystal material of a liquid crystal display does not itself emit light. Rather, a back light module is needed.

A conventional back light module includes a light source and a light guide plate. The light source is disposed adjacent an incident surface of the light guide plate. The light source is a linear light source or one or more point light sources. The light guide plate transforms light beams emitted from the linear light source or point light source(s) into a surface light source. A plurality of dots is formed on the bottom surface of the light guide plate, so as to destroy the total internal reflection condition for light beams transmitted within the light guide plate. The dots can also aid the diffusion of light beams, so as to enhance the homogeneity of the outgoing light. The distribution density and size of the dots may be adapted to comply with different back light module designs.

Referring to FIG. 1, a conventional back light module 9 is illustrated. The back light module 9 comprises a light guide plate 10, a semi-transparent plate 20 (optional), a reflective material box 30, and a plurality of light sources 40. The semi-transparent plate 20 is disposed on the light guide plate 10. A peripheral edge and a bottom surface of the light guide plate 10 are enclosed in the reflective material box 30. Each light source 40 is disposed in a respective positioning groove 31 defined in one side of the reflective material box 30. In operation, light beams from the light sources 40 are incident to one side surface of the light guide plate 10. The light beams go through the light guide plate 40 and provide a homogeneous surface light source emitting through an upper surface 11 of the light guide plate 10, by means of dots on a bottom surface 12 of the light guide plate 10 and the reflective material box 30. The semi-transparent plate 20 makes the surface light source even more homogeneous.

Referring now to FIG. 2, the propagation of light beams in the conventional light guide plate 10 is illustrated. As shown, each light source 40 has an emission angle . For a light emitting diode (LED), for example, is normally in the range of between 30° and 130°. However, because the peripheral surface of the light guide plate 10 corresponding to the light source 40 is a flat surface, the light beams are refracted, which reduces the emission angle to an effective emission angle ′ in the light guide plate 10. The maximum effective emission angle ′ is approximately 120°. Consequently, large darkened areas 13 are formed, thus reducing the homogeneity and luminescence of the outgoing light.

In order to solve the above-mentioned problem, another kind of light guide plate has been developed. This is disclosed in China New Utility Model Patent No. ZL03200375.7 published in Dec. 31, 2003. As shown in FIG. 3, the light guide plate 10′ defines a plurality of holes 14 arranged to correspond to a pattern of light wave fronts of each of light sources. The holes 10 may be through holes penetrating through the light guide plate 10′. The incident light beams may be refracted or total reflected when encountering the holes 14, which helps reduce or even eliminate the existence of darkened areas.

However, the holes 14 are disposed adjacent the incident surface of the light guide plate 10′. Parts of the incident light beams are liable to be reflected or total reflected out of the light guide plate 10′ after encountering the holes 14. Therefore the amount of incident light beams propagating into the light guide plate 10′ is reduced.

### SUMMARY OF THE INVENTION

One objective of the present invention is to provide a back light module and a method for manufacturing the same, whereby a light guide plate of the back light module has reduced darkened areas.

Another objective of the present invention is to provide a back light module and a method for manufacturing the same, whereby the back light module has a surface light source with high homogeneity.

In order to achieve the above and other objectives, a back light module of the present invention comprises a light guide plate defining a plurality of triangular grooves along a peripheral surface thereof, and a plurality of light sources positioned corresponding to the triangular grooves. Light beams generated by each light source, especially those light beams at extremities of the light source's emission angle, can thus penetrate through the peripheral surface of the light guide plate without refraction. In contrast to the darkened areas in a light guide plate of a conventional back light module, the light guide plate of the back light module of the present invention has much smaller darkened areas.

Further, a preferred method for manufacturing a back light module comprises the steps of: providing a light guide plate having at least one triangular groove defined in one peripheral surface thereof; and positioning at least one light source at the at least one groove of the light guide plate in one-to-one correspondence.

Other objectives, advantages and novel features of the invention will become more apparent from the following detailed description when taken in conjunction with the accompanying drawings.

### BRIEF DESCRIPTION OF THE DRAWINGS

FIG. 1 is an exploded view of a conventional back light module.

FIG. 2 illustrates light propagation paths of the back light module of FIG. 1.

FIG. 3 is a schematic, top elevation of a conventional light guide plate.

FIG. 4 is an perspective view of a back light module in accordance with a first embodiment of the present invention.

FIG. 5 illustrates light propagation paths of the back light module of FIG. 4.

FIG. 6 is a top elevation of a back light module in accordance with a second embodiment of the present invention.

FIG. 7 is a perspective view of a back light module in accordance with a third embodiment of the present invention.

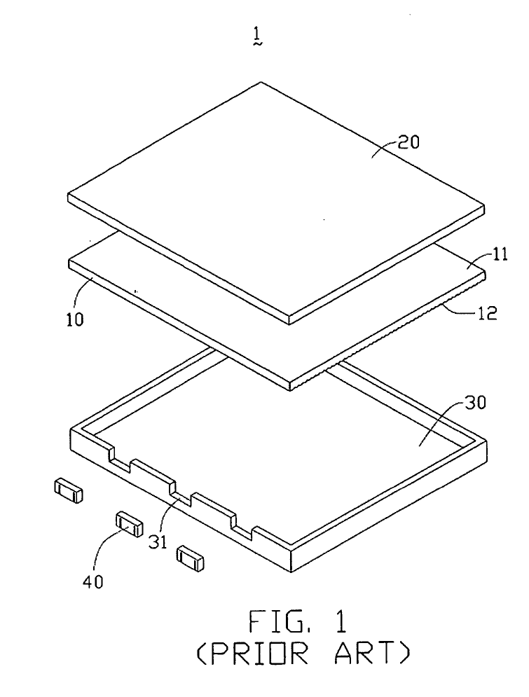

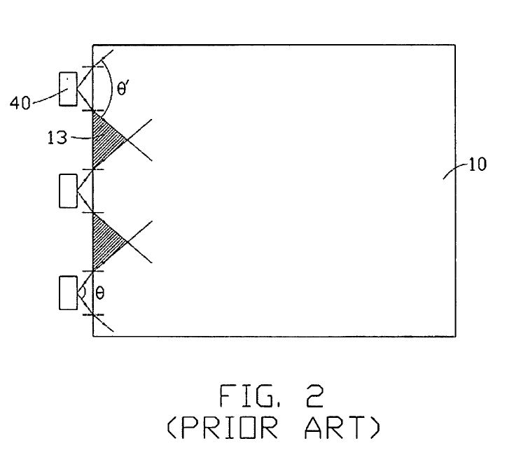

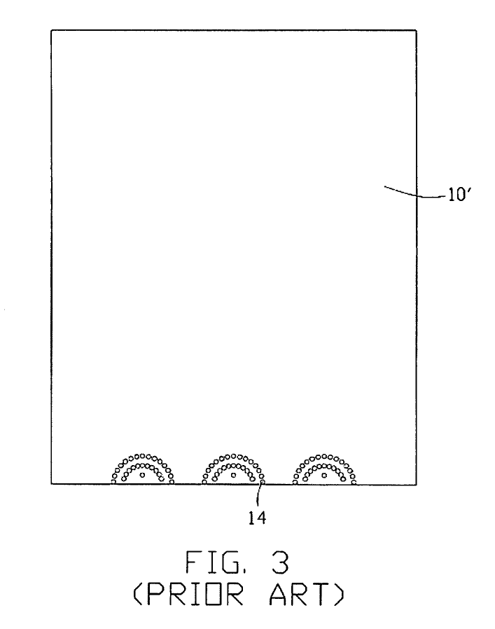

### DETAILED DESCRIPTION OF THE INVENTION

### FIRST EMBODIMENT

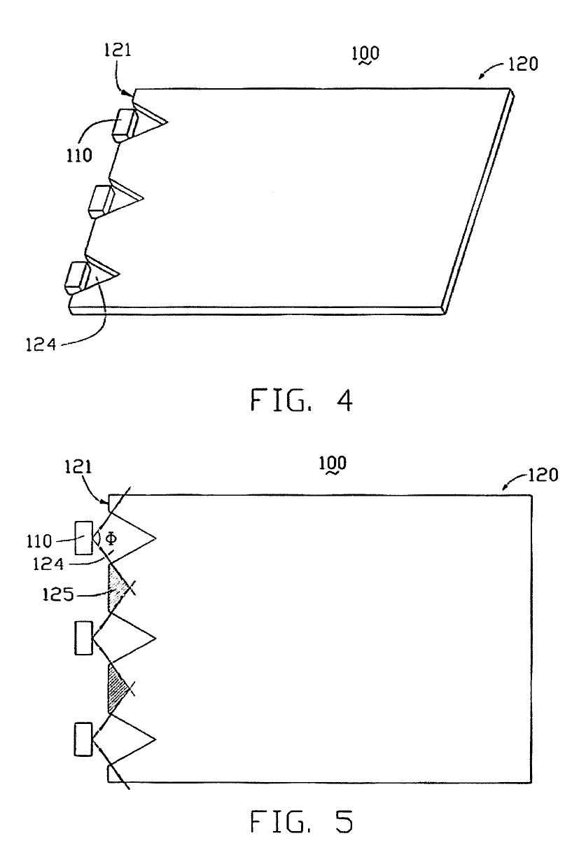

Referring to FIG. 4, a back light module 100 in accordance with the first embodiment of the present invention is illustrated. The back light module 100 comprises at least a plurality of light sources 110 and a light guide plate 120. A plurality of triangular grooves 124 is defined along a peripheral side 121 of the light guide plate 120, each groove 124 corresponding to a respective light source 110. In this particular embodiment, each light source 110 is a point light source such as a light emitting diode (LED) or a light bulb. The light guide plate 120 is made of a transparent material such as glass, acrylic resin or polycarbonate.

Referring to FIG. 5, light propagation paths of the back light module 100 are illustrated. As shown, each light source 110 has an emission angle . Due to the presence of the triangular groove 124, a portion of the light beam at to each extremity of the emission angle may penetrate through the peripheral side 121 of the light guide plate 120 without any reduction in the effective emission angle. Therefore, a darkened area 125 is significantly reduced in size. It is appreciated that the triangular grooves 124 defined along the peripheral side 121 of the light guide plate 120 may be instead have other shapes. For instance, the triangular grooves 124 may be replaced by semi-circular grooves.

### SECOND EMBODIMENT

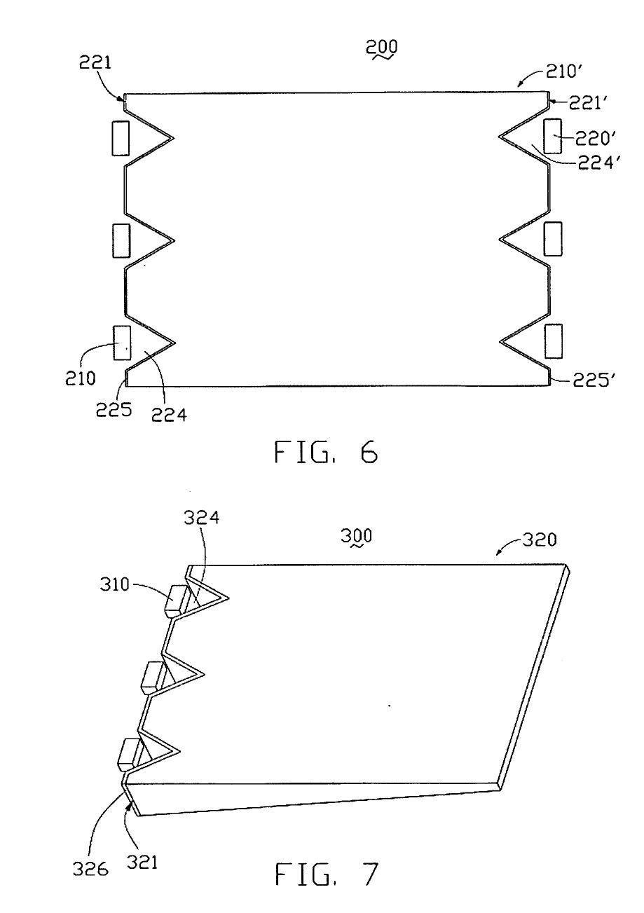

Referring now to FIG. 6, a back light module 200 in accordance with the second embodiment of the present invention is illustrated. The back light module 200 comprises a light guide plate 220, a plurality of first light sources 210, and a plurality of second light sources 210′. Along a first peripheral side 221 of the light guide plate 220, a plurality of triangular grooves 224 is defined. Each triangular groove 224 corresponds to a respective first light source 210. Along a second peripheral side 221′ of the light guide plate 220, a plurality of triangular grooves 224′ is defined. Each triangular groove 224′ corresponds to a respective second light source 210′. In this particular embodiment, the first peripheral side 221 and the second peripheral side 221′ are two opposite sides of the light guide plate 220. In addition, one may employ optional penetration enhancement films 225, 225′ along the peripheral sides 221, 221′, so as to enhance the amount of light entering the light guide plate 220.

### THIRD EMBODIMENT

Referring to FIG. 7, a back light module 300 in accordance with the third embodiment of the present invention is illustrated. As shown, the back light module 300 comprises a light guide plate 320 and a plurality of light sources 310. The light guide plate 320 is wedge shaped. A plurality of triangular grooves 324 is defined along a thicker peripheral side 321 of the light guide plate 320, each triangular groove 324 corresponding to a respective light source 310. One may optionally employ a penetration enhancement film 326 along the thicker peripheral side 321, so as to enhance the amount of light entering the light guide plate 320.

A preferred method for manufacturing a back light module comprises the steps of: providing a light guide plate having at least one groove defined in one peripheral surface thereof; and positioning at least one light source at the at least one groove of the light guide plate in one-to-one correspondence. One may optionally add the step of forming a penetration enhancement film on the peripheral surface having the at least one groove, so as to enhance the amount of light entering the light guide plate. It is noted that the at least one groove of the light guide plate is preferably triangular.

Although the present invention has been described in detail in terms of the above embodiments, other embodiments may be practiced. A person having ordinary skill in the art may make modifications and/or alterations that are within the scope of the present invention or equivalent to the present invention. Therefore, the subject matter sought to be patented is that which is defined in the following claims.

1. A back light module, comprising:
at least one light source; and
a light guide plate, wherein at least one groove is defined in a peripheral side thereof, said groove corresponding to said light source in one-to-one relationship for guiding light into the light guide plate.

2. The back light module of claim 1, further comprising a penetration enhancement film formed on the peripheral side having said groove.

3. The backlight module of claim 1, wherein said light source is a point light source.

4. The backlight module of claim 3, wherein said light source is a light emitting diode or a light bulb.

5. The back light module of claim 1, wherein the light guide plate is made of a transparent material such as glass, acrylic resin and polycarbonate.

6. The back light module of claim 5, wherein the light guide plate is made of glass, acrylic resin or polycarbonate.

7. The back light module of claim 1, wherein said groove is triangular.

8. A method for manufacturing a back light module, comprising the steps of:
providing a light guide plate having at least one groove defined in one peripheral surface thereof; and
positioning at least one light source at said groove of the light guide plate in one-to-one correspondence.

9. The method of claim 8, further comprising the following step before the step of positioning at least one light source at said groove of the light guide plate in one-to-one correspondence:
forming a penetration enhancement film on the peripheral surface having said groove.

10. The method of claim 8, wherein said groove is triangular.

11. The back light module as claimed in claim 1, wherein an intersection area of said groove and said peripheral side is located within an emission angle of the corresponding light source.

12. The back light module as claimed in claim 11, wherein said groove around said intersection area confronts said light source at about a right angle.
